(19) United States
(12) Patent Application Publication
(10) Pub. No.: US 2011/0091063 A1
(43) Pub. Date: Apr. 21, 2011

(54) METHOD AND APPARATUS FOR PREVENTING WRONG RECOGNITION OF EARPHONE INSERTION

(75) Inventor: Sang-Hee LEE, Suwon-si (KR)

(73) Assignee: SAMSUNG ELECTRONICS CO. LTD., Suwon-si (KR)

(21) Appl. No.: 12/905,621

(22) Filed: Oct. 15, 2010

(30) Foreign Application Priority Data
Oct. 19, 2009 (KR) 10-2009-0099129

(51) Int. Cl. H04R 1/10

(52) U.S. Cl. 381/384

(57) ABSTRACT

A method and an apparatus for recognizing earphone insertion are provided. In the method, whether an earphone is inserted is determined. When earphone insertion is determined, a discontinuous Direct Current (DC) voltage is applied to a microphone end of an earphone jack. A magnitude of the discontinuous DC voltage of the earphone jack is determined. Whether the earphone jack is a three-pole earjack or a four-pole earjack is determined depending on the determined magnitude of the discontinuous DC voltage. Therefore, erroneous recognition of the earphone insertion may be prevented.

### PRIORITY

This application claims the benefit under 35 U.S.C. §119(a) of a Korean patent application filed in the Korean Intellectual Property Office on Oct. 19, 2009 and assigned Serial No. 10-2009-0099129, the entire disclosure of which is hereby incorporated by reference.

### BACKGROUND OF THE INVENTION

1. Field of the Invention

The present invention relates to mobile communication terminal that uses an earphone. More particularly, the present invention relates to a method and an apparatus for preventing erroneous recognition when an earphone is inserted into a mobile communication terminal.

2. Description of the Related Art

Recently, as the mobile communication terminal industry has developed and digital technology has progressed, mobile communication terminals are now available that provide additional functions for allowing not only voice communication but also video communication. As an example of an additional function of a mobile terminal, a hands-free function may be provided wherein the mobile terminal has an earjack port for connecting to an earjack.

FIGS. 1A and 1B are views illustrating an earjack according to the related art.

Referring to FIG. 1A, a three-pole earjack is illustrated. The three-pole earjack is divided into a signal portion R for a right side earphone, a signal portion L for a left side earphone, and a ground portion GND. When the three-pole earjack is inserted into an earphone port of a mobile communication terminal, the signal portion R for the right side earphone, the signal portion L for the left side earphone, and the ground portion GND of the three-pole earjack are closely attached to the earphone port of the mobile communication terminal so that an electrical signal of the mobile communication terminal is transferred to an earphone, or an electrical signal of the earphone is transferred to the mobile communication terminal.

Referring to FIG. 1B, a four-pole earjack is illustrated. The four-pole earjack is divided into a signal portion R for a right side earphone, a signal portion L for a left side earphone, a microphone sensing portion, and a ground portion GND. When the four-pole earjack is inserted into an earphone port of a mobile communication terminal, the signal portion R for the right side earphone, the signal portion L for the left side earphone, the microphone sensing portion, and the ground portion GND of the four-pole earjack are closely attached to the earphone port of the mobile communication terminal, so that an electrical signal of the mobile communication terminal is transferred to an earphone, or an electrical signal of the earphone is transferred to the mobile communication terminal. In addition, the microphone sensing portion of the four-pole earjack transfers a voice signal generated from a microphone to the mobile communication terminal.

When the three-pole earjack or the four-pole earjack is inserted into the mobile communication terminal, the mobile communication terminal recognizes that the three-pole or four-pole earjack has been inserted based on the magnitude of a voltage applied to the microphone sensing portion of the four-pole earjack.

However, in the case where a 3.5 mm earphone is inserted into the mobile communication terminal, when the earphone is inserted inaccurately or slowly, the magnitude of a voltage applied to the microphone sensing portion of the four-pole earjack is inaccurate, so that erroneous recognition of earjack insertion is caused. For example, in the case where a three-pole earjack is recognized as a four-pole earjack, a voltage is applied to the microphone sensing portion such that unnecessary current consumption occurs. On the other hand, in the case where a four-pole earjack is recognized as a three-pole earjack, a voltage is not applied to the microphone sensing portion, which causes an inconvenience to a user.

Therefore, a method and an apparatus for accurately recognizing earjack insertion in a communication apparatus that uses an earphone are required.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for preventing erroneous recognition of earphone insertion.

Another aspect of the present invention is to provide a method and an apparatus for minimizing current consumption during recognition of earphone insertion.

In accordance with an aspect of the present invention, a method for recognizing earphone insertion is provided. The method includes determining whether an earphone is inserted, when determining that an earphone is inserted, applying a discontinuous Direct Current (DC) voltage to a microphone end of an earphone jack, determining a magnitude of the discontinuous DC voltage passing through the a microphone end of the earphone jack, and determining whether the earphone jack is a three-pole earjack or a four-pole earjack based on the determined magnitude of the discontinuous DC voltage.

In accordance with another aspect of the present invention, a method for recognizing earphone insertion is provided. The method includes, when detecting the earphone insertion, applying a DC voltage to a microphone end of an earphone jack during a first time period, and switching off the DC voltage during a second time period, before the second time period starts, measuring a DC voltage of the microphone end of the earphone jack, and determining whether the earphone jack is a three-pole earjack or a four-pole earjack according to the measured DC voltage level.

In accordance with still another aspect of the present invention, an apparatus for recognizing earphone insertion is provided. The apparatus includes a detector for determining whether an earphone is inserted, a power supply unit for, when determining that an earphone is inserted, applying a discontinuous DC voltage to a microphone end of an earphone jack, and a controller for determining a magnitude of the discontinuous DC voltage passing through the microphone end of the earphone jack, and for determining whether the earphone jack is a three-pole earjack or a four-pole earjack according to the determined magnitude of the discontinuous DC voltage.

In accordance with further another aspect of the present invention, an apparatus for recognizing earphone insertion is provided. The apparatus includes a switching unit for, when detecting earphone insertion, applying a DC voltage to a microphone end of an earphone jack during a first time period, and for switching off the DC voltage during a second time period, and a controller for measuring a DC voltage level passing through the microphone end of the earphone jack before the second time period starts, and for determining whether the earphone jack is a three-pole earjack or a four-pole earjack according to the measured DC voltage level.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B are views illustrating an earjack according to the related art;

FIG. 2 is a block diagram illustrating an apparatus for preventing erroneous recognition of earphone insertion according to an exemplary embodiment of the present invention;

FIG. 3A illustrates a Direct Current (DC) power supplied during a discontinuous mode according to an exemplary embodiment of the present invention;

FIG. 3B illustrates a DC power supplied during a continuous mode according to an exemplary embodiment of the present invention;

FIG. 4 is a block diagram illustrating a terminal for preventing erroneous recognition of earphone insertion according to an exemplary embodiment of the present invention; and

FIG. 5 is a flowchart illustrating an operation for preventing erroneous recognition of earphone insertion in a mobile communication terminal according to an exemplary embodiment of the present invention.

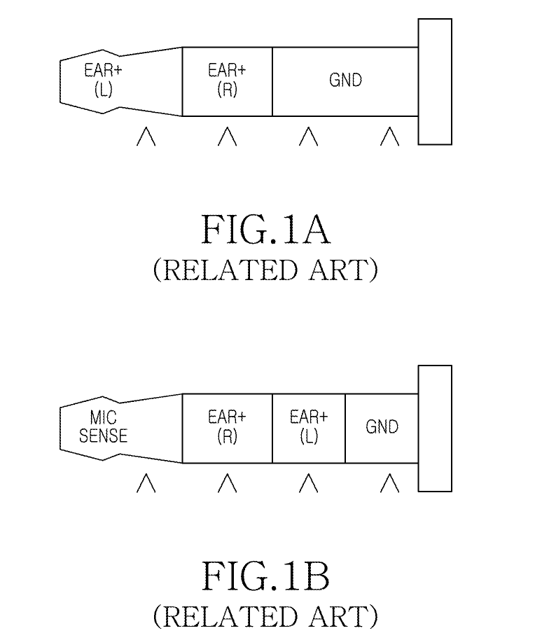

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and an apparatus for preventing erroneous recognition of earphone insertion.

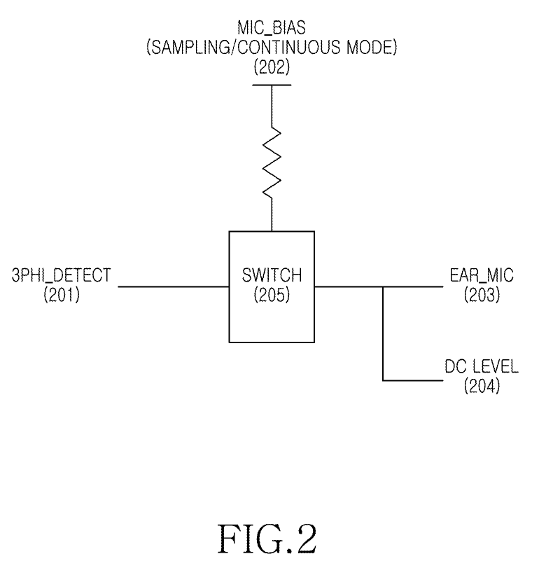

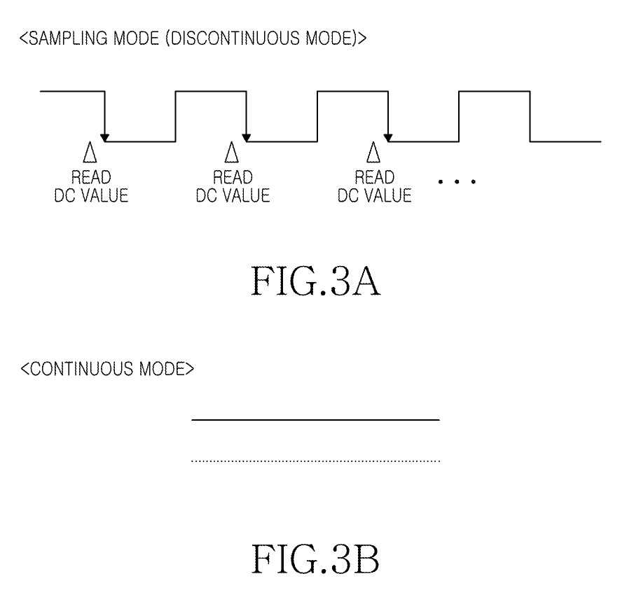

FIG. 2 is a block diagram illustrating an apparatus for preventing erroneous recognition of earphone insertion according to an exemplary embodiment of the present invention. FIG. 3A illustrates a Direct Current (DC) power supplied during a discontinuous mode according to an exemplary embodiment of the present invention. FIG. 3B illustrates a DC power supplied during a continuous mode according to an exemplary embodiment of the present invention.

Referring to FIG. 2, when an earjack is inserted into a relevant apparatus (for example, a mobile communication terminal, a multimedia apparatus, etc.), the relevant apparatus recognizes that the earjack has been inserted using a detection end 3PHI_DETECT 201.

When recognizing that the earjack has been inserted, the relevant apparatus operates in a sampling mode or a continuous mode to supply DC power to the earjack via a bias end MIC_BIAS 202. For example, as in FIG. 3A, during the sampling mode, a continuous voltage magnitude is controlled by a switch 205 such that power is supplied discontinuously. In the following description, the term “sampling mode” is used in a manner so as to have substantially the same meaning as a “discontinuous mode.” During the continuous mode, as in FIG. 3B, a DC voltage magnitude supplied from the relevant apparatus is supplied continuously by the switch 205.

The switch 205 supplies power from the relevant apparatus continuously or discontinuously corresponding to the sampling mode or the continuous mode. At this point, DC voltage is applied to a microphone end EAR_MIC 203, so that a voltage drop occurs.

The relevant apparatus determines whether a three-pole earjack or a four-pole earjack has been inserted by measuring (e.g., at DC Level measuring point 204) a voltage applied to the microphone end EAR_MIC 203.

During the discontinuous mode, the DC voltage may be measured at a point at which a DC voltage is blocked as illustrated in FIG. 3A. Depending on implementation, a point of measuring a DC voltage magnitude may be determined as an arbitrary point within a section during which a DC voltage is applied.

Here, a voltage measurement period or point may be realized in a relevant apparatus in a software or hardware manner. In other words, the switch 205 may be realized inside the relevant apparatus in a software or hardware manner.

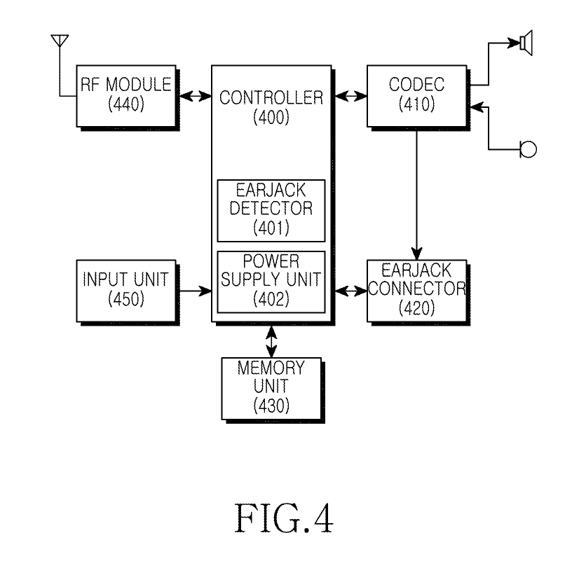

FIG. 4 is a block diagram illustrating a terminal for preventing erroneous recognition of earphone insertion according to an exemplary embodiment of the present invention.

Referring to FIG. 4, the terminal includes a controller 400, a codec 410, an earjack connector 420, a memory unit 430, a Radio Frequency (RF) module 440, and an input unit 450. The controller 400 may include an earjack detector 401 and a power supply unit 402.

The controller 400 of the terminal controls an overall operation of the terminal. For example, the controller 400 performs processes and controls for voice communication and data communication. In addition to the general functions, the controller 400 controls to detect whether an earjack is inserted in the earphone connector 420 and to allow a DC voltage to be applied to a microphone end of the earjack depending on the continuous mode or the discontinuous mode. For this purpose, the earjack detector 401 of the controller 400 determines whether the earjack is inserted by detecting an electrical signal flowing through a detection end when the earjack is inserted into the earjack connector 420.

When the earjack detector 401 detects earjack insertion, the power supply unit 402 applies a discontinuous DC voltage to the earphone via the earjack connector 420. In addition, depending on whether it is determined that the earjack is a three-pole earjack or a four-pole earjack, the power supply unit 402 blocks power when determining that the earjack is a three-pole earjack, and applies a discontinuous or continuous DC voltage when determining that the earjack is a four-pole earjack.

The codec 410 has a data codec that processes packet data and an audio codec that processes an audio signal such as voice. The codec 410 converts a digital audio signal received from the controller 400 into an analog signal via the audio codec to reproduce the same, or converts an analog audio signal generated and transmitted from a microphone into a digital audio signal via the audio codec to transmit the same to the controller 400. The codec 410 may be provided separately or included in the controller 400.

The earjack connector 420 includes a plurality of ends that can be connected to an earphone to transfer voice and a control signal to the earphone, or transfers an electrical signal from the earphone to the controller 400.

The memory unit 430 of the terminal may include any or all of a Read Only Memory (ROM), a Random Access Memory (RAM), and a flash ROM. The ROM stores codes of programs for processing and control of the controller 400, and various reference data.

The RAM serves as a working memory of the controller 400 and stores temporary data occurring during execution of various programs. In addition, the flash ROM may store a phonebook, calling messages, received messages, and the like.

The RF module 440 transmits/receives an RF signal of data input/output via an antenna. For example, during transmission, the RF module 440 channel-codes and spreads data to be transmitted, and performs an RF process on the signal to transmit the signal. During reception, the RF module 440 converts a received RF signal into a baseband signal, and despreads and channel-decodes the baseband signal to recover data.

The input unit 450 includes a plurality of function keys such as numerical key buttons of 0 to 9, a menu button, a cancel (delete) button, an OK button, a TALK button, an END button, an Internet access button, navigation key (or directional key) buttons, letter input keys, etc., and provides key input data corresponding to a key pressed by a user to the controller 400.

The functions of the earjack detector 401 and the power supply unit 402 may be performed separately from the controller 400 of the terminal. Configuration and illustration of the earjack detector 401 and the power supply unit 402 inside the controller are for convenience in description only, and are not for limiting the scope of the present invention. That is, it would be obvious to those skilled in the art that various modifications may be made within the scope of the present invention.

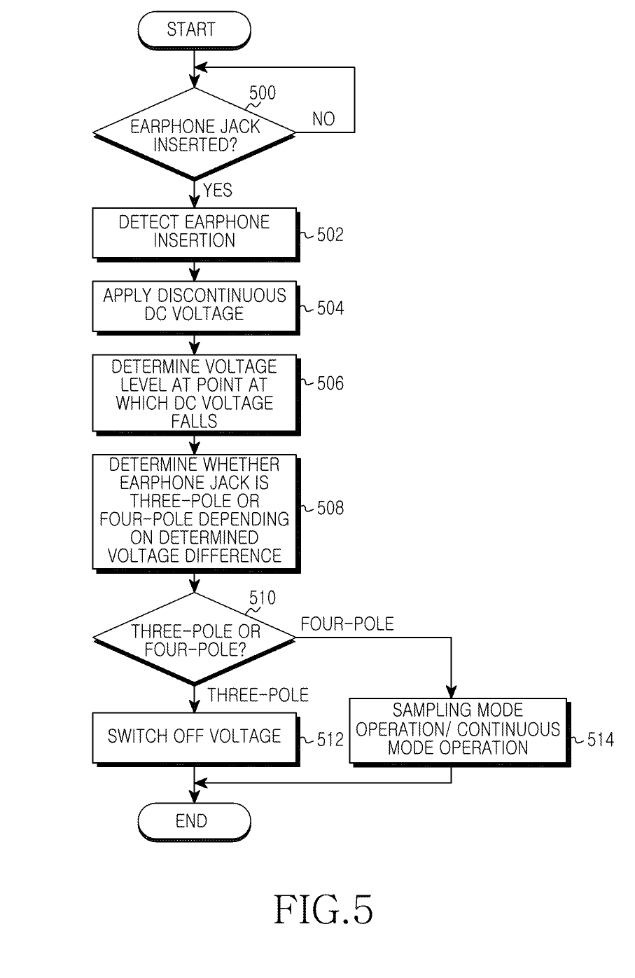

FIG. 5 is a flowchart illustrating an operation for preventing erroneous recognition of earphone insertion in a mobile communication terminal according to an exemplary embodiment of the present invention.

Referring to FIG. 5, the terminal determines if an earphone jack is inserted into the earphone connector 420 in step 500. If it is determined in step 500 that an earphone jack is inserted into the earphone connector 420, the terminal detects insertion of the earphone using a detection end of the earphone connector 420 in step 502.

In step 504, the terminal applies a discontinuous DC voltage to a microphone end of the earphone jack as illustrated in FIG. 3B. The discontinuous DC voltage may be generated when a continuous DC voltage is repeatedly blocked during a predetermined section by the power supply unit 402.

In step 506, the terminal determines a voltage magnitude applied to the microphone end of the earphone jack at a point at which the DC voltage is blocked (e.g., in FIG. 3A, at the point at which the DC voltage magnitude falls). In an exemplary implementation, the terminal determines a difference between the voltage magnitude applied to the microphone end of the earphone jack when the DC voltage is blocked and the voltage magnitude applied to the microphone end of the earphone jack when the DC voltage is not blocked.

In step 508, the terminal compares the determined voltage difference with a threshold. The result of the comparison is used to determine whether the earjack is a three-pole earjack or a four-pole earjack.

In step 510, the terminal determines if the earjack is a three-pole earjack or a four-pole earjack. If it is determined in step 510 that the earjack is a three-pole earjack, the terminal blocks power supplied to the microphone end in step 512.

In contrast, if it is determined in step 510 that the earjack is a four-pole earjack, the terminal operates in a sampling mode (discontinuous mode) continuously, and, when a voice is input via a microphone, operates in a continuous mode as illustrated in FIG. 3B to apply a DC voltage continuously in step 514. This is for preventing the muting of a communication or a voice recording.

As described above, exemplary embodiments of the present invention may prevent erroneous recognition that may occur in the case where an earjack is inserted falsely or slowly, and minimize current consumption by synchronizing and measuring a discontinuous voltage magnitude applied to a microphone end at a relevant point.

As further described above, exemplary embodiments of the present invention provide the advantage of preventing erroneous recognition of earphone insertion by using a sampling signal when an earphone is inserted. In addition, current consumption for recognizing earphone insertion may be minimized.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for recognizing earphone insertion, the method comprising:
determining whether an earphone is inserted;
when determining that an earphone is inserted, applying a discontinuous Direct Current (DC) voltage to a microphone end of an earphone jack;
determining a magnitude of the discontinuous DC voltage passing through the microphone end of the earphone jack; and
determining whether the earphone jack is a three-pole earjack or a four-pole earjack based on the determined magnitude of the discontinuous DC voltage.

2. The method of claim 1, further comprising, when determining that the earphone jack is a three-pole earjack, switching off power supplied to the microphone end of the earphone jack.

3. The method of claim 1, further comprising, when determining that the earphone jack is a four-pole earjack, continuing to apply the discontinuous DC voltage to the microphone end of the earphone jack while an input is not received by a microphone.

4. The method of claim 1, further comprising, when determining that the earphone jack is a four-pole earjack, applying a continuous DC voltage to the microphone end of the earphone jack while an input is received by a microphone.

5. The method of claim 1, wherein the determining of the magnitude of the discontinuous DC voltage comprises determining the magnitude of the discontinuous DC voltage before the discontinuous DC voltage falls.

6. The method of claim 5, wherein the determining of the magnitude of the discontinuous DC voltage further comprises:
determining a magnitude of the DC voltage after the discontinuous DC voltage falls; and
determining a difference between the magnitude of DC voltage before the discontinuous DC voltage falls and after the discontinuous DC voltage falls.

7. A method for recognizing earphone insertion, the method comprising:
when detecting earphone insertion, applying a Direct Current (DC) voltage to a microphone end of an earphone jack during a first time period, and switching off the DC voltage during a second time period;
before the second time period starts, measuring a DC voltage level of the microphone end of the earphone jack; and
determining whether the earphone jack is a three-pole earjack or a four-pole earjack according to the measured DC voltage level.

8. The method of claim 7, further comprising, when determining that the earphone jack is a three-pole earjack, switching off power supplied to the microphone end of the earphone jack.

9. The method of claim 7, further comprising, when determining that the earphone jack is a four-pole earjack, applying a discontinuous DC voltage to the microphone end of the earphone jack while an input is not received by a microphone.

10. The method of claim 7, further comprising, when determining that the earphone jack is a four-pole earjack, applying a continuous DC voltage to the microphone end of the earphone jack while an input is received by a microphone.

11. An apparatus for recognizing earphone insertion, the apparatus comprising:
a detector for determining whether an earphone is inserted;
a power supply unit for, when determining that an earphone is inserted, applying a discontinuous Direct Current (DC) voltage to a microphone end of an earphone jack; and
a controller for determining a magnitude of the discontinuous DC voltage passing through the microphone end of the earphone jack, and for determining whether the earphone jack is a three-pole earjack or a four-pole earjack according to the determined magnitude of the discontinuous DC voltage.

12. The apparatus of claim 11, wherein, when determining that the earphone jack is a three-pole earjack, the power supply unit switches off power supplied to the microphone end of the earphone jack.

13. The apparatus of claim 11, wherein, when determining that the earphone jack is a four-pole earjack, the power supply unit continues to apply the discontinuous DC voltage to the microphone end of the earphone jack while an input is not received by a microphone.

14. The apparatus of claim 11, wherein, when determining that the earphone jack is a four-pole earjack, the power supply unit applies a continuous DC voltage to the microphone end of the earphone jack while an input is received by a microphone.

15. The apparatus of claim 11, wherein the determining of the magnitude of the discontinuous DC voltage comprises determining the magnitude of the discontinuous DC voltage when the discontinuous DC voltage falls.

16. The apparatus of claim 15, wherein the determining of the magnitude of the discontinuous DC voltage further comprises:
determining a magnitude of the DC voltage after the discontinuous DC voltage falls; and
determining a difference between the magnitude of DC voltage before the discontinuous DC voltage falls and after the discontinuous DC voltage falls

17. An apparatus for recognizing earphone insertion, the apparatus comprising:
a switching unit for, when detecting earphone insertion, applying a Direct Current (DC) voltage to a microphone end of an earphone jack during a first time period, and switching off the DC voltage during a second time period; and
a controller for measuring a DC voltage level passing through the microphone end of the earphone jack before the second time period starts, and for determining whether the earphone jack is a three-pole earjack or a four-pole earjack according to the measured DC voltage level.

18. The apparatus of claim 17, wherein, when determining that the earphone jack is a three-pole earjack, the switching unit switches off power supplied to the microphone end of the earphone jack.

19. The apparatus of claim 17, wherein, when determining that the earphone jack is a four-pole earjack, the switching unit applies a discontinuous DC voltage to the microphone end of the earphone jack while an input is not received by a microphone.

20. The apparatus of claim 17, wherein, when determining that the earphone jack is a four-pole earjack, the switching unit applies a continuous DC voltage to the microphone end of the earphone jack while an input is received by a microphone.
